(19) United States
(12) Patent Application Publication
(10) Pub. No.: US 2006/0188399 A1
(43) Pub. Date: Aug. 24, 2006

(54) Analytical sensor system for field use

(75) Inventor: G. Edzko Smid, Oakland Township, MI (US)

Correspondence Address: GIFFORD, KRASS, GROH, SPRINKLE & CITKOWSKI, P.C, PO BOX 7021, TROY, MI, 48007-7021, US

(73) Assignee: JADI, Inc., Troy, MI (US)

(21) Appl. No.: 11/346,712

(22) Filed: Feb. 3, 2006

Related U.S. Application Data
(60) Provisional application No. 60/650,417, filed on Feb. 4, 2005.

(51) Int. Cl. G01N 27/02

(52) U.S. Cl. 422/82.02; 422/68.1; 73/24.06

(57) ABSTRACT

A piezoelectric analytical sensor system is provided that includes a piezoelectric crystal having a sensing surface. The piezoelectric crystal is driven at a base oscillation frequency that is responsive to an analyte interacting with the sensing surface of the crystal. A crystal resonator in mechanical communication with the crystal drives the crystal at the base oscillation frequency. An electronic circuit is provided for measuring a vibrational frequency of the crystal and relating the vibrational frequency to a quantity of the analyte in contact with the sensing surface of the piezoelectric crystal. A modular interface in electrical communication with the electronic circuit is provided to engage an electronic device and derive power from that electronic device.

### RELATED APPLICATION

This application claims priority of U.S. Provisional Patent Application Ser. No. 60/650,417 filed Feb. 4, 2005, which is incorporated herein by reference.

### FIELD OF THE INVENTION

The present invention in general relates to a piezoelectric sensor for an analyte, and in particular to a piezoelectric sensor formed as a miniature module amenable to coupling to a variety of portable electronic devices and an efficient analyte analysis process.

### BACKGROUND OF THE INVENTION

Piezoelectric sensors represent a well established and reliable method for performing analyte detection and quantification. However, the transition of piezoelectric sensors from the laboratory to the field conditions experienced by military, oil exploration and mining crews, and environmental quality monitoring has been hampered by factors including the delicacy and size of sensor analysis electronics/power supplies and the susceptibility of piezoelectrics towards aerosol particulate and changes in environmental conditions. Additionally, the replacement of a fouled piezoelectric sensor currently requires considerable skill to perform the necessary recalibration. As a result of these limitations, the comparative cost and sensitivity of piezoelectric sensors for field applications has suffered relative to other detection technologies.

Thus, there exists a need for a compact modular piezoelectric sensor suited for use as a peripheral to a variety of portable electronic devices.

### SUMMARY OF THE INVENTION

A piezoelectric analytical sensor system is provided that includes a piezoelectric crystal having a sensing surface. The piezoelectric crystal is driven at a base oscillation frequency that is responsive to an analyte interacting with the sensing surface of the crystal. A crystal resonator in mechanical communication with the crystal drives the crystal at the base oscillation frequency. An electronic circuit is provided for measuring a vibrational frequency of the crystal and relating the vibrational frequency to a quantity of the analyte in contact with the sensing surface of the piezoelectric crystal. A modular interface in electrical communication with the electronic circuit is provided to engage an electronic device and derive power from that electronic device.

A process for operating a piezoelectric analytical sensor system to determine the mass of an analyte includes driving a piezoelectric crystal having a sensing surface at a base oscillation frequency responsive to the analyte mass. The piezoelectric crystal is exposed to an analyte for a sufficient time for the analyte mass to adhere to the sensing surface. The oscillation frequency of the piezoelectric crystal is sampled for a first time interval to yield a first analog pulse count which is then converted to a first digital signal and measured within a digital counter bin. The oscillation frequency is then sampled for a second time interval to yield a second analog pulse count with the second analog pulse count then being converted to a second digital signal. The analyte mass is calculated as a fit between the first digital signal defined as a number of overruns of said counter bin capacity and a first remainder and the second digital signal defined as a second number of overruns of said counter bit capacity and a second remainder.

### BRIEF DESCRIPTION OF THE DRAWINGS

The present invention is detailed with respect to the following non-limiting illustrations that identify only specific embodiments of the present invention.

FIG. 1 is an exploded view of an inventive piezoelectric sensor system;

FIG. 2 is an electrical schematic depicting the relationship between multiple sensors, processing and communications components;

FIG. 3 is a graphical plot of signal characteristics for a series in parallel oscillators relative to component schematics; and

FIG. 4 is a schematic of a piezoelectric sensor system data analysis process according to the present invention with pulse widths not depicted to scale for visual clarity.

### DETAILED DESCRIPTION OF THE INVENTION

The present invention has utility as a sensor for a variety of liquid or gas borne analytes. The inventive piezoelectric sensor system is modular and allows a user to customize the piezoelectric crystals within the system, as well as providing a baffle to extend the life and performance of the crystals. An inventive piezoelectric analytical sensor system is provided as a standalone card or having a modular interface for coupling piezoelectric circuitry with an electronic device so as to communicate results with the device and/or derive power therefrom.

By way of example, the inventive system is suitable for field use to detect land mines, explosives, chemical weapons, chemical leakage and biohazards through detection of trace quantities of molecules emitted from the target source and carried to the inventive piezoelectric analyte sensor system by a carrier such as a gas or liquid. Air and water are the most commonly encountered gas and liquid carriers, respectively. Based on the small dimensions of an inventive system, the modularity and the flexibility in terms of analyte detection, individuals such as first aid responders, utility company field workers, consumers, and soldiers in the field are expected to find the present invention affording earlier and more sensitive detection of potential hazards, as compared to equipment currently in use.

An inventive sensor preferably includes two or more distinct detection mechanisms for a given analyte. In addition to a quartz crystal microbalance mass sensing device, an electrochemical amperometric sensing device is also optionally provided. Inclusion of multiple detection mechanisms significantly reduces false results and makes the resulting system more robust. Still additional improvements are realized through a novel signal analysis technique that entails pulse width modulation sampling or a piezoelectric sensor in collecting sensor response obtained after passing the signal through an analog-to-digital converter and noting the number of pulses obtained in a particular pulse width modulation window. An inventive analysis methodology uses a comparatively small number of bits such as a sixteen-bit processor and binning the signal into a number of overrun occurrences and a remainder left in the counter. In this way, numerical values beyond counter capacity (65,536 for a sixteen-bit processor) are rapidly tabulated as a multiple of this capacity plus an overrun value.

In a particular aspect of the present invention, a sensor system is used to detect vapors associated with explosives. Representative explosives known to have appreciable vapor pressures include 2,4,6-trinitrotoluene (TNT), triacetone triperoxide (TATP), ammonia nitrate, hexahydro-1,3,5-trinitro-1,3,5-triazine. The difficulty conventional gas sensors have encountered in detecting explosives is associated with interfering, non-explosive compounds found in the environment such as water vapor, diesel fuel, gasoline, and other non-explosive odors. As these interfering, non-explosive gaseous compounds are typically found in much higher concentration in air sampling than those of explosives, successful detection of explosive vapors requires the separation and distinguishment of interfering non-explosive compounds as a detected signal. Piezoelectric sensing sensitivity to target species such as the illustrative explosive vapors described above requires inclusion of a chemical layer on the piezoelectric sensor selective for a target species of interest. Derivatizing a metal electrode surface on a piezoelectric sensor is well known to the art and has included the use of cyclodextrins as a preorganized rigid hydrophobic cavity highly interactive with trinitrotoluene and dinitrotoluene nitro groups associated with these explosive compounds (X. Yang et al., Talanta 54, 439 (2001)); calixerenes (P. G. Datskos et al., Sensor Letters 1(1), 25 (2003)); and immobilized antibodies (A. Hengerer et al., BioTechniques 26(5), 956 (1999)).

Optionally, electrochemical amperometric electrodes are placed proximal to an inventive piezoelectric sensor in order to selectively absorb a target analyte and decompose the target analyte to a species detectable by the proximal piezoelectric crystal mass balance.

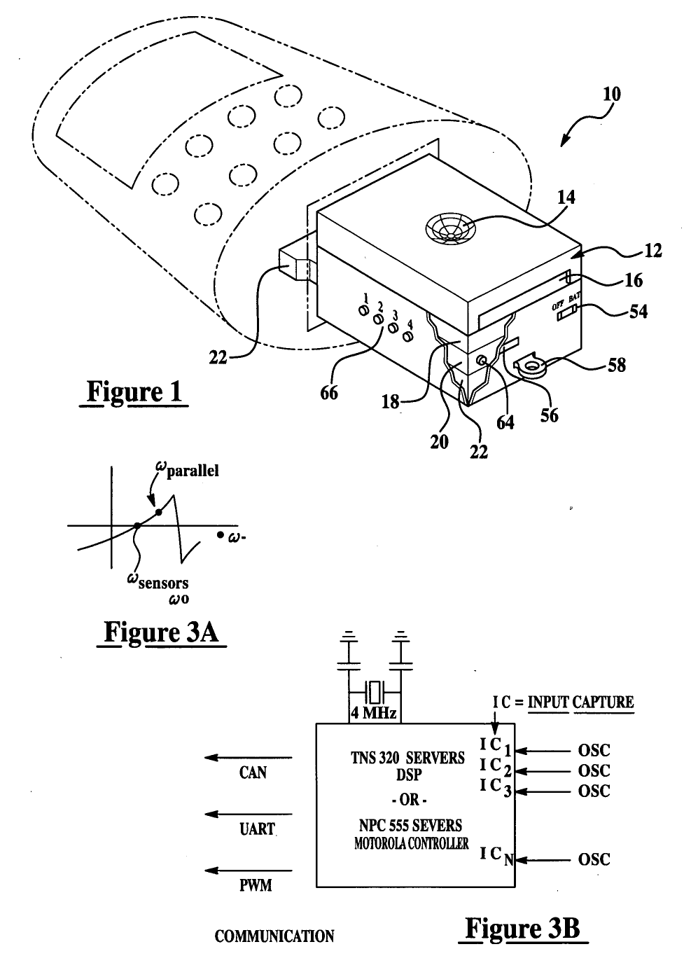

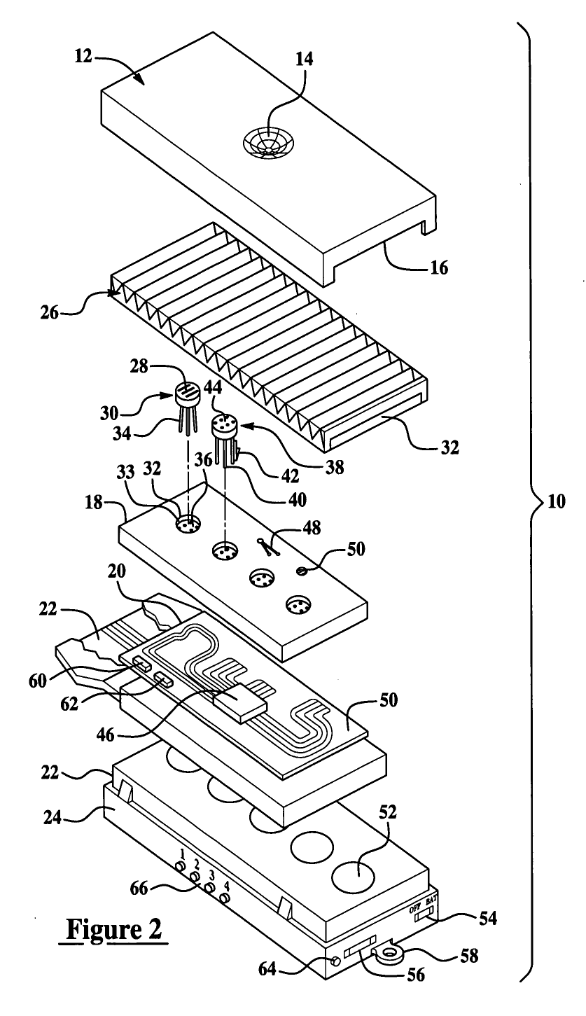

Referring now to FIGS. 1 and 2, an inventive sensor system is shown generally at 10. The system 10 is depicted interfaced with a PDA (shown in ghost). It is appreciated that in addition to a PDA, an external electronic device from which an inventive system 10 can derive power and/or upload analyte sensing information illustratively includes a laptop computer, a cellular telephone or a Blackberry. The system 10 is configured in the general shape of a laminate card. A removable sensor cover 12 overlies piezoelectric crystals and provides a measure of protection against dust and debris buildup on the active piezoelectric crystal surface. The cover 12 has a well depression 14 for the sampling of a liquid. An exit aperture 16 is also provided in the sensor cover 12. The sensor cover 12 is formed of an impact-resistant material illustratively including aluminum, brass, steel, polycarbonate and copolymers containing butadiene and styrene. The sensor cover 12 overlies a crystal element layer 18. The crystal element layer 18 is in simultaneous contact with an electronics layer 20. The electronics layer 20 terminates in a modular interface 22 adapted to engage the electronic device. An optional self-contained power supply layer 22 is provided for those circumstances where analyte sensing is desired at a location remote from an electronic device. Layers 18, 20 and 22 are contained within a housing 24 matable to the sensor cover 12 to form a rugged and impact-resistant package. The housing 24 is formed of materials such as those from which the sensor cover 12 is formed.

Beneath sensor cover 12 a filtration baffle 26 is provided such that a gaseous or liquid carrier containing particulate debris is filtered to remove the majority of debris prior to the carrier contacting an active piezoelectric crystal surface 28. It is appreciated that the introduction of a baffle 26 decreases the diffusional rate of an analyte from the well depression 14 where it is introduced until reaching the active surface 28 of a piezoelectric crystal 30. As such, a pull tab 32 is provided on the baffle 26 to afford the user the option to remove the baffle 26 in those instances where maximal system response time is considered necessary. The sensor cover 12 is selectively removable to replace or otherwise clean a baffle 26. A piezoelectric crystal 30 couples to a crystal resonator depression 32 found within a crystal element layer 18 by way of multiple pins 34. The pins 34 engage complementary holes 36 in the crystal resonator depression 32. The number of holes 36 is typically greater than the maximum number of pins 34. Preferably, the array of holes 36 are aligned asymmetrically such that the piezoelectric 30 is only engaged in a specific orientation. The specific holes 36 engaged by pins 34 of the piezoelectric 30 is unique to the analyte specificity of surface 28. In an alternate embodiment, piezoelectric crystal 38 has a pin 40 in parallel with a resistor, the surface 44 being responsive to a particular analyte. The electronic circuit 46 automatically senses the identity of piezoelectric 30 or 38 either through the pin arrangement alone, the characteristic parallel resistor value associated with pin 40, or a combination thereof. In this way, a crystal element layer 18 is loaded with piezoelectric crystals particular for analytes of interest. With the electronic circuit 46 sensing the characteristics of a given piezoelectric, subsequent operation of a piezoelectric crystal is performed with baseline calibration information logged within the electronic circuit 46. Baseline characteristics including frequency change per unit, mass change, Δf/ΔM, integral mass sensitivity C_{f}, differential mass sensitivity, drift, hysteresis, response time, resonant frequency and harmonic frequency for the piezoelectric crystal. While in FIG. 2, crystal element layer 18 is depicted with four crystal resonator depressions for the sake of visual clarity, it is appreciated that a greater number of simultaneously operative piezoelectrics are accommodated in an inventive system 10. Sixteen, thirty-two or an even greater number of piezoelectric crystals are recognized to be operative with an inventive device. In addition to mounting multiple piezoelectric crystals, each of which is sensitive to a different analyte, it is appreciated that mounting multiple piezoelectric crystals of similar sensitivity to a given analyte affords improved signal-to-noise response for a given analyte. Likewise, simultaneous use of multiple piezoelectric crystals that vary between high sensitivity-narrow range and low sensitivity-wide range in detection of a given analyte provide complementary information that upon combination results in a broader effective functional range for detection of an analyte. While any type of piezoelectric crystal is in principle operative as part of an inventive system 10, preferably a piezoelectric crystal is based on a quartz crystal microbalance (QCM). The properties of quartz crystal microbalances are well known to the art. Buck et al., Pure Applied Chemistry 76(6), 1139-1160 (2004). Surface coatings applied to a piezoelectric crystal to make the crystal responsive to a particular analyte have no limitation according to the present invention. Piezoelectric crystal surface coatings operative herein illustratively include those disclosed in U.S. Pat. Nos. 5,866,798; 5,185,129; 4,243,631; 3,864,324; and 3,778,229. In a preferred embodiment, the crystal element layer 18 also comprises at least one environmental condition sampler. In the embodiment depicted in FIG. 2, the environmental condition samplers include a thermocouple 48 and a humidity sensor 50. Additional environmental parameter data that is useful in improving the performance of a piezoelectric crystal under field conditions illustratively include a pressure transducer and a pH meter. The crystal element layer 18 derives power to drive the crystal resonator 33 and communicates piezoelectric crystal oscillation frequency information and information about the identity of a given piezoelectric crystal to an electronic circuit layer 20. The electronic circuit layer 20 includes a circuit board 50 to facilitate this communication. The electronic circuit 46 measures the vibrational frequency of each piezoelectric crystal and relates that frequency to a quantity of analyte in contact with the piezoelectric surface. The electronic circuit 46 is in a format such as compact flash or PCMCIA in order to facilitate communication with conventional portable electronic devices such as a personal digital assistant (PDA), laptop computer, or cellular communication device. A modular interface 22 is in electrical communication with the electronic circuit 46. The modular interface is adapted to engage a portable electronic device and derive power from that device. In this way, an inventive system 10 leverages power and communication abilities of an existing device likely to be carried by a user and thereby reduce such redundant systems from an inventive system. Optionally, inventive system 10 includes a battery power supply 52 in order to allow operation of an inventive system 10 independent from a portable electronic device. A switch 54 is provided to allow the system 10 to be deenergized or operated off of battery power. An indicator LED 56 communicates to a user whether an inventive system is operating in an active sensing mode. To facilitate use of an inventive system 10 in an independent mode, free of a portable electronic device, an eyelet 58 is provided on the housing 24 so that inventive system 10 can be suspended or worn about the neck of a user. To facilitate operation of an inventive system in a freestanding mode, the electronic circuit 46 is coupled with an indicator system including a vibratory cam 60 and/or an acoustic indicator 62. It is appreciated that a light emitting diode visual indicator is also operative herewith to provide visual notice of detection. However, in the context of a military setting, in many instances visual detection requires a user to draw their focus away from the surrounding area. A switch 64 is provided to allow a user to select between various forms of notification such as off, vibration and acoustic buzzer. Additionally, a user interface 66 allows a user to select which of the array of piezoelectrics within an inventive system 10 is active to trigger user alert.

Electronic circuit 46 provides a sensor output to a coupled electronic device in a variety of communication protocols. Communication protocols in which data is communicated illustratively include JAUS in use by the United States Department of Defense, CAN associated with an automotive vehicle network, or JEMPERS associated with mobile Microsoft networks.

In an alternate embodiment, an inventive system includes a wireless communication transponder in place of or in combination with the modular interface 22 as depicted in FIG. 2. A wireless capability allows one to create a mesh of sensing systems disposed in the field so that diffusion and spreading behavior of a given analyte is communicated to a remote location. A sensor system well suited for dispersion in the field lacks the modular interface 22 switches 54 and 64, as well as user interface 66 and eyelet 58. Such a system necessarily includes an onboard power supply 52. Upon determining the location of a given sensor system in the field either through global positioning satellite logging or conventional signal triangulation, the communicated sensor signals from a variety of such systems spread within an area provide a geographical gradient map of analyte concentration in an area of interest. Wireless communication as used herein is preferably a radiofrequency technology integrated into circuit board 50. Wireless communication protocols operative herein illustratively include IEEE 802.15.a, IEEE 802.11, standard Ethernet protocol, Zigbee standard or that currently used with Bluetooth® personal devices.

In an alternate embodiment, the housing and sensor cover are optionally configured to include a power source making the system freestanding and amenable to dispersion in a hazardous environment such as an area prone to exposure to chemical warfare agents or the planting of explosives. Distribution of a variety of systems according to the present invention in such an environment coupled with a wireless connectivity communication capability allows an environment to be sampled for potential hazards without the need to subject humans or even autonomous robotic vehicles within the environment. It is appreciated that a spherical or flechette-shaped housing is particularly well suited for dispersal from a low-flying aerial vehicle.

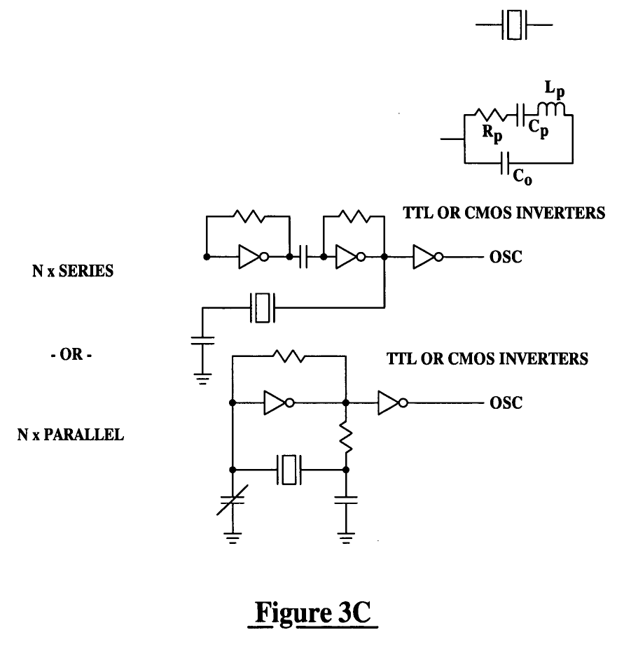

FIG. 3 depicts frequency response for a piezoelectric QCM depicting the frequency associated with a piezoelectric operating in series and in parallel relative to the pure theoretical frequency of the crystal. Also depicted in FIG. 3 is the electronic circuit corresponding to 46 in FIG. 2 receiving oscillation information from a piezoelectric at each of C₁-C₃. The configuration of an oscillator (OSC) as being a series or parallel oscillator consistent with FIG. 3A is depicted in FIG. 3C. In order to improve the sensitivity of an inventive electronic circuit as depicted in FIG. 3B, and at 46 in FIG. 2, a reference clock is provided. The reference clock provides a simultaneous input electronic circuit and is configured as shown in FIG. 3D. Since the sensing ability of an inventive system directly relates to the quality of the reference clock, a highly accurate reference is preferably used such as an ovenized or high quality rubidium piezoelectric crystal is used as the reference clock. It is further appreciated that measuring higher harmonic frequencies, frequency filtering for the use of a frequency counter of boosted (PLL) frequency as known are all operative herein to improve the accuracy of piezoelectric crystal output and correlation to analyte concentration.

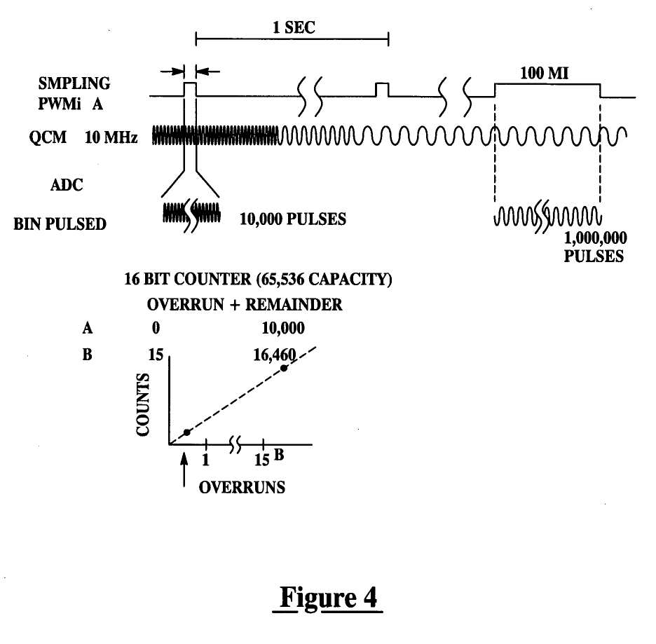

FIG. 4 depicts as a schematic a piezoelectric sensor system data analysis process according to the present invention. A piezoelectric quartz crystal mass balance is oscillated at a frequency responsive to analyte mass. It is appreciated that accuracy in an inventive system increases exponentially with the piezoelectric crystal bass frequency. By way of example, increasing the piezoelectric crystal base frequency from 10 megahertz to 25 megahertz results in a sensitivity increase by a factor of greater than 6. It is also appreciated that the piezoelectric crystal achieves specificity for a particular analyte for coating the active piezoelectric crystal surface with a coating with which the analyte preferentially reacts relative to other substances found in the sampled environment. The schematic of FIG. 4 includes a piezoelectric crystal (QCM) operating at 10 megahertz. A sampling pulse width modulation (PWM) samples the QCM for a first time period spaced a preselected amount of time from the next sampling period. A sampling PWM window A is a 1 millisecond collection bin spaced at 1 second intervals and after analog-to-digital conversion 10,000 pulses are logged into a microelectronic counter. While FIG. 4 denotes a 16-bit counter having a numerical counting capacity of 65,536, it is appreciated that a state of the art microcontroller such as the 32-bit RISC microcontrollers (Motorola) are ideally used herein. The 10,000 pulses collected with PWM A constitute zero overruns and a remainder of 10,000. Sampling with PWM A is repeated for a preselected amount of time to improve the statistical accuracy of the resulting value. The microcontroller then applies a PWM B having a duration different from that of PWM A. As depicted in FIG. 4, a 100 millisecond PWM yields 1,000,000 in pulses that constitute in a 16-bit counter 15 overruns and a remainder of 16,960. Repetition of PWM B for a preselected amount of time improves the signal-to-noise average and statistical accuracy of the measurement. A fit between the values obtained from PWM samplings A and B yields a value for the sensed quantity of analyte. A typical PWM is between 0.01 and 10 milliseconds with a second time interval preferably being at least one order of magnitude greater than the first PWM time interval and preferably between 1.5 and 3 orders of magnitude greater than the first PWM time interval. Also, it is appreciated that the analysis scheme detailed herein is operative with a comparatively longer first PWM relative to a second, third or other varied pulse width modulation time interval. The measurement of data relating to an environmental parameter such as temperature, pressure, humidity, or pH that can impact response of a piezoelectric crystal to analyte concentration is preferably used to adjust the binned value prior to calculation of sensed analyte.

Patent documents and publications mentioned in the specification are indicative of the levels of those skilled in the art to which the invention pertains. These documents and publications are incorporated herein by reference to the same extent as if each individual document or publication was specifically and individually incorporated herein by reference.

The foregoing description is illustrative of particular embodiments of the invention, but is not meant to be a limitation upon the practice thereof. The following claims, including all equivalents thereof, are intended to define the scope of the invention.

1. A piezoelectric analytical sensor system comprising:
a piezoelectric crystal having a surface, said crystal having a base oscillation frequency responsive to an analyte;
a crystal resonator in mechanical communication with said crystal;
an electronic circuit for measuring a vibrational frequency of said crystal and relating the vibrational frequency relative to the base oscillation frequency to a quantity of the analyte in contact with the surface; and
a modular interface in electrical communication with said electronic circuit, said interface adapted to engage an electronic device and derive power from said electronic device.

2. The system of claim 1 further comprising a plurality of piezoelectric crystals.

3. The system of claim 2 wherein said plurality of piezoelectric crystals each produces an output sensitive to the analyte.

4. The system of claim 3 wherein the output from each of said plurality of piezoelectric crystals is communicated to said electrical circuit to improve accuracy in quantifying the quantity of the analyte in contact with the surface.

5. The system of claim 1 further comprising a second piezoelectric crystal having a second oscillation frequency responsive to a second analyte.

6. The system of clam 1 wherein said electronic circuit is in a format selected from the group consisting of: compact flash and PCMCIA.

7. The system of claim 1 further comprising a wireless communication transponder.

8. The system of claim 7 further comprising a communication protocol in controlling communication between said electronic circuit and said transponder.

9. The system of claim 8 wherein said communication protocol is selected from the group consisting of: IEEE 802.15.a, IEEE 802.11, Zigbee standard, and Bluetooth.

10. The system of claim 1 wherein said piezoelectric is secured to said crystal resonator with a pronged connector communicative to said electrical circuit the analyte that said crystal is responsive to.

11. The system of claim 1 wherein said piezoelectric is secured to said crystal resonator in parallel with a resistor having an ohmic resistance communicative to said electrical circuit the analyte that said crystal is responsive to.

12. The system of claim 1 further comprising an environmental condition sampler measuring a datum relating to an environmental parameter selected from the group consisting of: temperature, pressure, humidity, and pH, said datum being communicated to said electronic circuit.

13. The system of claim 10 wherein said datum is used by said electronic circuit to improve accuracy in quantifying the quantity of the analyte in contact with the surface.

14. A process for operating a piezoelectric analytical sensor system to determine an analyte mass comprising:
driving a piezoelectric crystal having a surface at base oscillation frequency responsive to the analyte mass;
exposing said piezoelectric crystal to an analyte for sufficient time for the analyte mass to adhere to the surface;
sampling the oscillation frequency for a first time interval to yield a first analog pulse count;
converting the first analog pulse count to a first digital signal;
sampling the oscillation frequency for a second time interval to yield a second analog pulse count;
converting the second analog pulse count to a second digital signal;
calculating the analyte mass as a fit between the first digital signal defined as a number of overruns of said counter bit capacity and a first remainder and the second digital signal defined as a number of overruns of said counter bit capacity and a second remainder.

15. The process of claim 14 wherein the first time interval and the second time interval may be at least one order of magnitude.

16. The process of claim 15 wherein one of the first time interval and the second time interval is between 0.01 and 10 milliseconds.

17. The process of claim 14 wherein the oscillation frequency is adjustable between within one order of magnitude of 10 megahertz.

18. The process of claim 14 wherein the surface of said piezoelectric crystal further comprises an analyte-specific coating.

19. The process of claim 14 further comprising measuring a datum relating to an environmental parameter and using said datum in the step of calculating the analyte mass through a fit refinement.
